(19) United States
(12) Patent Application Publication
(10) Pub. No.: US 2013/0240427 A1
(43) Pub. Date: Sep. 19, 2013

(54) COMPONENT FOR A FILTER UNIT FOR FILTERING FLUIDS AND METHOD FOR PRODUCING SUCH A COMPONENT

(71) Applicants: Jessica Parino, Neunkirchen (DE); Michael Sakraschinsky, St. Ingbert (DE)

(72) Inventors: Jessica Parino, Neunkirchen (DE); Michael Sakraschinsky, St. Ingbert (DE)

(21) Appl. No.: 13/261,608

(22) PCT Filed: Aug. 11, 2011
(86) PCT No.: PCT/EP11/04014

§ 371 Date: Jun. 6, 2013

(30) Foreign Application Priority Data
Sep. 1, 2010 (DE) 10 2010 035 981.5

(51) Int. Cl. B01D 35/06

(52) U.S. Cl. CPC B01D 35/06
USPC 210/222; 427/128; 427/130; 427/558; 427/550

(57) ABSTRACT

The invention relates to a component (30) for a filter unit for filtering fluids, in particular hydraulic fluids, comprising at least in areas an insertion or application of magnetisable and/or magnetised particles, whereby, using a simplified design, a magnetic separation of contaminants in a fluid flowing through a filter unit is achieved. The component can be in the form of a film (30) and can be an externally or circumferentially arranged support means for a filter element (10). In the manufacture of the component (30), said component is provided at least in areas with an insertion and/or application of magnetisable and/or magnetised particles.

The invention relates to a component for a filter unit for filtering fluids, in particular hydraulic fluids.

More than 70% of failures of lubricating and hydraulic systems are caused by the media, i.e., the operating medium plays a decisive role in hydraulic systems. The cleaner the medium and the better it is protected against external effects, such as contaminants in solid, liquid, and/or gaseous form, the more efficiently and economically a system can be operated. The objective of filtration is to improve the operating behavior and to extend the service life of the components of a hydraulic system and in this way to reduce the operating costs. The choice of the optimum filtration solution contributes significantly to preventing damage by fouling or adulteration, to increasing system availability, and thus to markedly enhancing productivity. The intensity of damage to components is dependent on the material of the fouling, on the operating (over)pressure, on the composition (round or sharp-edged), as well as the size and number of dirt particles. In this connection, it is often not understood that most of these solid particles are smaller than 30 μm and cannot be detected with the naked eye. Thus an apparently clean fluid can in fact be seriously fouled.

In hydraulic systems, there are different types of filter units which are named according to their installation site and/or their function. Pressure filters are located, for example, in the main flow of the system (downstream of the pump) and are subject to special demands on the housing owing to the higher pressure that prevails there. A return line filter, conversely, is located on the return line of the system to the tank and is not exposed to high pressure there; therefore, it can be installed in a lightweight housing design. A filter housing consists of the filter head, which comprises the inlet and outlet for connection to the hydraulic system, and a filter bowl in which there is a filter element. The filter housing can moreover be equipped with a bypass valve and a clogging indicator. The filter elements installed in the filter housing as the main component of the filter unit perform the actual filtration work.

DE 10 2007 004 492 A1 discloses a filter unit with components of the initially named type. The known filter element for cleaning of fluids has a jacket body which surrounds a filter cavity with passages for cleaned fluid, an end cap which seals the jacket body on one end, a holder which seals the jacket body on the other end with at least one passage for the fluid to be cleaned to flow into an inflow region within the filter cavity, a filter medium which extends between the end cap and holder and through which the fluid to be cleaned flows from the inflow region, and at least one permanent magnetic component which extends from the inside of the holder into the inflow region.

The magnetic component is at least one bar-like magnetic core which extends away from the holder along a longitudinal direction of the filter element in the direction of the end cap. Because the magnet system extends over a longitudinal region of the filter cavity in this case, magnetic prefiltration takes place. The releasable safety device makes it possible to separately remove the magnetic core, for example, for maintenance or diagnostic purposes. In the known filter element, additional mechanical effort and installation space in the filter element are necessary for the magnetic cores. Moreover, the magnetic cores located in the inflow region may influence the fluid flow in an undesirable manner.

Relative to this prior art, the object of the invention is to achieve magnetic separation of contaminants in a fluid which is flowing through a filter unit with simplified mechanical effort.

This object is achieved according to the invention by a component having the features specified in claim 1 in its entirely. Because the component at least in certain areas has an introduction and/or application of magnetizable and/or magnetized particles, this component acquires an additional function, and a separate magnetic component such as magnetic cores can be omitted. Thus a magnetic separation function can be located in a filter unit of small size and especially on a component which does not adversely affect the fluid flow. The introduction and/or application of the magnetizable or magnetized particles is relatively uncomplicated since it can be integrated into the production of the component and the filter unit.

In one preferred embodiment of the component according to the invention, the particles are ferromagnetic, especially neodymium-iron-boron particles. The material combination neodymium-iron-boron exhibits good properties of a permanent magnet.

Furthermore, it is advantageous for the size of the particles to be in the μm range, especially in the nm range. An introduction and/or application of particles of this size can be done in a very thin layer onto the component so that hardly any installation space is taken up, and moreover simple, especially homogeneous, particle application can be achieved via a suspension.

In another preferred embodiment of the invention, the application can be made as a coating of at least one surface area of the component. A coating can be easily applied to the component, for example using a spray gun, and with the desired thin application thickness.

It is furthermore advantageous for the coating to comprise at least one lacquer layer of a coating lacquer, and especially to be formed from several, preferably four, lacquer layers. It has been shown that here a coating lacquer which contains nanoparticles can be used and achieves good results with respect to adhesion, magnetization, and magnetic field strength in an application in four lacquer layers, with a layer thickness as uniform as possible, and applied in a crossed application.

Advantageously, the component is provided with passages for a fluid, especially is made perforated and/or sieve-like. This yields the advantage that the component which has been modified according to the invention can be located in the flow of a fluid to be filtered and a maximum possible filtration action by the magnetic particles can be achieved. In this connection, the component can be located on the filter housing, on the filter basket, or on the filter element itself or can be an integral part of it.

It is moreover feasible to provide the introduction and/or application on one surface area of the component assigned to the unfiltrate side. Thus, metallic solid particles or particles of fouling can be removed as early as possible from the fluid which is to be filtered, and thus fouling of downstream filter elements or filter components can be avoided.

In another special configuration of the component according to the invention, at least one surface of the component is blanketed with the introduction and/or application, especially with the coating. In this configuration, a maximum possible area is available for magnetic prefiltration. In particular, a component through which the fluid has flowed can be provided with the magnetic particles on an outer side or unfiltrate side and on an inner side or filtrate side of a filter element through which flow has taken place from the outside to the inside in order to achieve the best possible separation of metallic fouling particles.

It is furthermore advantageous that the component according to the invention be part of a preferably multilayer filter element. The multilayer filter element can be especially preferably a so-called mesh-pack with filter layers and support layers which are folded in a star shape and which are placed around a stabilizing support tube and are held stably in position by an outer filter mat. Depending on the filter material, the filter mat is surrounded by an outer envelope, especially a plastic envelope. In most cases, flow takes place through such a typically tubular-cylindrical filter element from the outside to the inside. In some instances, throughflow can also take place from the inside to the outside, for example, for cleaning purposes, and in this case in particular, the support tube and/or the sleeve can be omitted.

Accordingly, it is advantageous for the component according to the invention to be made as a film, sleeve, or jacket which is in particular a support means for a filter element, which support means is located on the outside, inside, or peripherally. In this way, the filtration performance of the filter element is increased by magnetic prefiltration and moreover the filter element is protected against additional fouling. The sleeve presses the mesh-pack against the support tube and fixes the folds. This yields a compact construction. In addition, the sensitive mesh-pack which has been folded in a star shape is protected against direct incident flow and against pulsation of the operating medium. The sleeve moreover serves as a diffuser which ensures a uniform distribution of the fluid flowing against the mesh-pack. Moreover, direct incident flow and destruction by dirt particles are avoided for the mesh-pack.

In one preferred embodiment, the component according to the invention is made at least partially from a preferably temperature-resistant, medium-compatible, and/or recyclable plastic material. Ideally, the plastic component which has been modified according to the invention corresponds completely to the following criteria for use in a filter unit: thickness<0.3 mm, can be imprinted, stable in a temperature range from −30° C. to +120° C., can be perforated, is compatible with the medium, and can be bonded.

The invention furthermore comprises a filter unit for filtering fluids with at least one component according to the invention which is located at least partially in the flow of the fluid to be filtered. The filter unit which is outfitted according to the invention is characterized by improved filtration performance and consequently improved operating behavior. The fluid to be cleaned flows against, around, and/or through the component which has the magnetic particles.

In one preferred embodiment of the filter unit according to the invention, there is a depth filter, and the at least one component is located in the fluid flow upstream of the depth filter. The filtration of solid particles which are smaller than 25 μm and which are mainly responsible for the reliability of the system is only possible with high-quality depth membrane filters. The filter materials installed in the depth membrane filters have extremely fine pores of varied size which are shaped by fibers and which are distributed over the entire filter material. They therefore have high dirt storage capacity with likewise high particle separation down to extremely small particles. To enhance these quality features which are important for system operators, high-quality filter elements are made with several layers, out of a prefilter nonwoven and a main filter nonwoven. Placing the magnetic component in the fluid flow upstream of the prefilter nonwoven results in prefiltration by metallic separation of metallic fouling particles; this leads to an improvement in the filtration performance of the depth membrane filter.

The subject matter of the invention is furthermore a method for producing a component for a filter unit for filtering fluids, especially for producing a component according to the invention, with the component being provided at least in certain areas with an introduction and/or application of magnetizable and/or magnetized particles. The method steps can follow the method for producing the component or can be integrated into it, but also can be carried out independently of it, especially optimized for the purpose of the component which has been functionalized with magnetizable and/or magnetized particles.

In one preferred version of the method according to the invention, the particles are applied as a coating in at least one surface area of the component. In this instance, it is moreover advantageous to apply at least one layer of a coating lacquer in the at least one surface area to the component, especially several, preferably four lacquer layers. In this version, magnetization of the component which is uniform over the surface area can be easily achieved.

In another version of the method according to the invention, in a subsequent method step, the coating is cured by heating of the component and/or by irradiation, especially with UV light. The curing can be carried out in a laboratory heating cabinet, typically for 15 minutes at 120° C. The dimension of a temperature treatment device such as a laboratory heating cabinet can be chosen depending on the size of the coated film or of the treated component. The use of a coating material which can be cured with UV light has the additional advantage that it can be applied and at the same time cured in a conventional printing machine. Thus the method according to the invention can be carried out in the method which is implemented for producing the component and especially with the device used in the process. By using a spray gun which is suitable for application of lacquers and dispersion paints, especially with compressed air or a pump, a more uniform surface application is achieved compared to a manual application by means of a brush.

Advantageously, the introduced and/or applied particles are magnetized by an external magnetic field. In this way, the magnetic field strength which is necessary to attract ferromagnetic particles from the medium or the fluid to be cleaned is generated and adjusted as necessary. With several lacquer layers, especially high magnetization can be achieved. When the corresponding surface area is magnetized, the magnetic particles are aligned by an external magnetic field. The external magnetic field is advantageously produced by a permanent magnet, especially a neodymium-iron-boron magnet, or by an electromagnet. In contrast to an electromagnet, a permanent magnet preserves its static magnetic field even without a current flow. To produce a relatively high external magnetic field, an appropriate material should be chosen. The magnetization of the component can be checked by means of a gradiometer. Demagnetization of the component installed in the filter unit by an inverted magnetic field, heating above the Curie temperature, and/or large mechanical loads can be for the most part ruled out in typical operation of a hydraulic system.

In another preferred version of the method according to the invention, the component is preferably printed in color, especially in the surface area which has the introduction and/or application. A company logo and/or type designation can be imprinted onto the component. In addition to an advertizing and information effect, it is easier to distinguish the components or filter units printed in this way from possibly copied products and thus to protect the replacement parts business for the companies. Depending on the color of the introduction or application, especially of the coating lacquer, the color for the imprint is chosen to be high-contrast, for example, red. For a dark gray or similar background, printing with white is likewise conceivable.

Other advantages and features of the invention will become apparent from the following description and the figures of the drawings. The features shown in the figures are purely schematic and should be understood as not to scale.

FIG. 1 shows a filter unit according to the prior art;

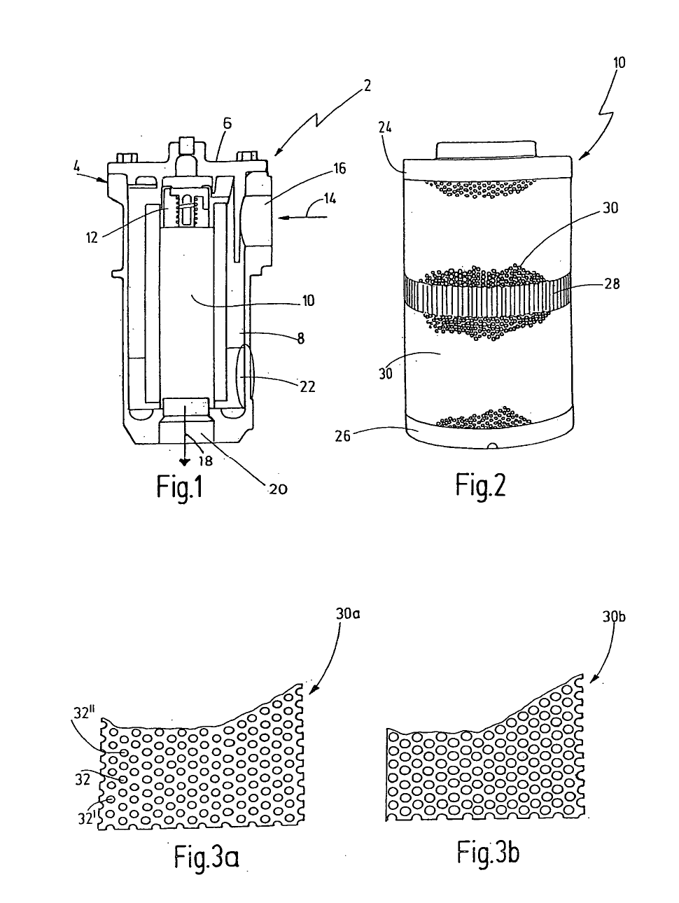

FIG. 2 shows a component according to the invention in the form of a filter element with magnetized film;

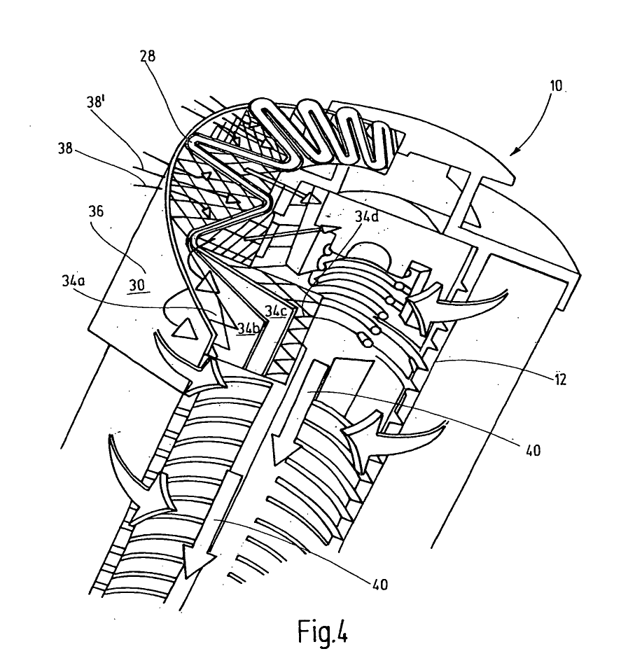

FIGS. 3a and 3b each show a plan view of one section of a component according to the invention in the form of a film with several layers of lacquer; and

FIG. 4 shows an end region of a component according to the invention with a filter element in an enlarged perspective.

FIG. 1 shows a filter unit 2 known from the prior art in a partially cutaway representation. A filter housing 4 of the filter unit 2 comprises a filter head 6 and a filter bowl 8 in which there is a filter element 10. The filter element 10 extends in the shape of a tubular cylinder around a support tube 12 which is shown in the region of the filter head 6. The fluid to be cleaned is routed in an inflow direction 14 on an inlet 16 provided in the filter housing 4 into the filter bowl 8, flows through the filter element 10 from the outside to the inside and leaves the filter unit 2 in the outflow direction 18 through an outlet 20. To separate metallic fouling particles from the unfiltered substance, on the lower end of the filter bowl 8 opposite the filter head 6, a magnetic tape 22 is arranged annularly in the interior of the filter bowl 8.

FIG. 2 shows a filter element 10 which has been modified according to the invention. Between an upper end cap 24 and a lower end cap 26, there extends a mesh-pack 28 which is visible only as a strip in a middle area of the filter element 10. The mesh-pack 28 is covered by a two-part film 30. It is advantageous to provide a film which corresponds to the complete longitudinal extension of the filter element 10 or of the mesh-pack 28. The film 30 is produced from a temperature-resistant plastic which is compatible with the medium and is made perforated to allow the passage of the fluid to be cleaned. On the illustrated outside of the film 30, it is blanketed with a coating with magnetizable particles and then magnetized. Thus the film 30 ensures magnetic prefiltration for separation of metallic fouling particles from a fluid to be cleaned. To improve this filtration and separation action, the film 30 on one inner side (not shown) can be provided in addition with a coating with magnetic particles. FIG. 2 shows that the film 30 which is used for stabilizing the position of the mesh-pack 28 in addition has a magnetic prefiltration action.

FIGS. 3a and 3b show in a plan view sections of the coated and magnetized film 30a and 30b. The films 30a and 30b differ by the number of applied lacquer layers, four in film 30a and six in film 30b. The films 30a, 30b have perforation openings 32, 32′, 32″ for fluid passage. To check the serviceability of the films 30a, 30b, they are weighed, inserted into a filter unit 2, and, after a certain period of operation, especially with the controlled addition of metallic fouling particles, such as iron powder, they are re-weighed. The measured weight difference results from the attracted fouling particles and those which have been separated from the fluid and is a measure of the filtration action of the films 30a, 30b. Here the use of a laboratory balance is advantageous, at least in test operation. The perforation openings 32, 32′, 32″ of the films 30a and 30b clog as the collection of metallic fouling particles on the films 30a and 30b increases; in other words, their diameter becomes smaller. In order to avoid disruptive effects on the throughflow behavior, the perforation openings 32, 32′, 32″ should be dimensioned accordingly.

FIG. 4 shows the filter element 10 with the mesh-pack 28 in an enlarged, partially cutaway perspective. The mesh-pack is folded up in the manner of pleats or in a star shape and is arranged annularly around the support tube 12. The layers 34a, 34b, 34c, 34d of the mesh-pack 28 are optimally matched to the requirements in the system and to the filter unit 2, are resistant to pressure peaks and changing volumetric flows, and are made as a support fabric, a support nonwoven, a main filter nonwoven, and/or a prefilter nonwoven. For the sake of improved clarity, the individual filter folds of the mesh-pack 28 are shown partially pulled apart, and the arrangement of the layers 34a-34d is apparent from the partial representation facing the viewer.

By longitudinal seam bonding of the film 30, a sleeve 36 is formed which surrounds the mesh-pack 28 and fixes it under radial tension on the support tube 12. The support tube 12 is made of steel and/or plastic. Arrows 38, 38′ show the throughflow direction through the sleeve 36 and the mesh-pack 28; in other words, flow takes place through the filter element 10 from the outside to the inside. Owing to the magnetization of the sleeve 36, metallic particles are already retained there. Other arrows 40 suggest the fluid direction in the support tube 12.

The functionalization or magnetization of a component, such as the film 30 or the sleeve 36, is not limited to the filter element 10, but can be provided on any other component of the filter unit 2, such as the filter housing 4, and especially the filter bowl 8. Furthermore, several components can be magnetized depending on the metallic fouling particles which are to be separated and can be located in the fluid flow. Diverse configurations as required are conceivable here.

1. A component (30, 36) for a filter unit (2) for filtering fluids, in particular hydraulic fluids, characterized in that the component (30, 36) at least in certain areas has an introduction and/or application of magnetizable and/or magnetized particles.

2. The component according to claim 1, characterized in that the particles are ferromagnetic, especially neodymium-iron-boron particles.

3. The component according to claim 1, characterized in that the size of the particles is in the μm range, especially in the nm range.

4. The component according to claim 1, characterized in that the application is made as a coating of at least one surface area of the component (30, 36).

5. The component according to claim 4, characterized in that the coating comprises at least one layer of a coating lacquer, and especially is formed from several, preferably four, lacquer layers.

6. The component according to claim 1, characterized in that the component (30, 36) is provided with passages (32, 32′, 32″) for a fluid, and especially is made perforated and/or sieve-like.

7. The component according to claim 1, characterized in that there is an introduction and/or application on one surface area of the component (30, 36) assigned to the unfiltrate side.

8. The component according to claim 1, characterized in that at least one surface of the component (30, 36) is blanketed with the introduction and/or application, especially with the coating.

9. The component according to claim 1, characterized in that the component (30, 36) is part of a preferably multilayer filter element (10).

10. The component according to claim 1, characterized in that the component (30, 36) is made as a film (30), sleeve (36), or jacket which is especially a support means for a filter element (10), which support means is located on the outside, inside, or peripherally.

11. The component according to claim 1, characterized in that the component (30, 36) is made at least partially from a preferably temperature-resistant, medium-compatible, and/or recyclable plastic material.

12. A filter unit (2) for filtering fluids with at least one component (30, 36) according to claim 1, with the at least one component (30, 36) being located at least partially in the flow of a fluid to be filtered.

13. The filter unit according to claim 12, characterized in that there is a depth filter and the at least one component (30, 36) is located in the fluid flow upstream of the depth filter.

14. A method for producing a component (30, 36) for a filter unit (2) for filtering fluids, especially according to claim 1, characterized in that the component (30, 36) at least in certain areas is provided with an introduction and/or application of magnetizable and/or magnetized particles.

15. The method according to claim 14, characterized in that the particles are applied as a coating in at least one surface area of the component (30, 36).

16. The method according to claim 15, characterized in that at least one layer of a coating lacquer in the at least one surface area is applied to the component (30, 36), with especially several, preferably four, lacquer layers being applied.

17. The method according to claim 15, characterized in that in a subsequent method step the coating is cured by heating of the component (30, 36) and/or by irradiation, especially with UV light.

18. The method according to claim 14, characterized in that the particles are magnetized by an external magnetic field.

19. The method according to claim 18, characterized in that the external magnetic field is produced by a permanent magnet, especially a neodymium-iron-boron magnet.

20. The method according to claim 18, characterized in that the external magnetic field is produced by an electromagnet.

21. The method according to claim 14, characterized in that the component (30, 36) is printed preferably in color, especially in the surface area which has the introduction and/or application.
